(19) United States
(12) Patent Application Publication
(10) Pub. No.: US 2026/0279859 A1
(43) Pub. Date: Sep. 17, 2026

(54) FUEL CELL SYSTEM AND CONTROL METHOD THEREOF

(71) Applicant: HONDA MOTOR CO., LTD., Tokyo (JP)

(72) Inventors: Takahiro NISHI, Wako-Shi (JP); Hiromichi INOUE, Wako-Shi (JP); Tomohito KOTAKE, Wako-Shi (JP)

(21) Appl. No.: 19/564,626

(22) Filed: Mar. 12, 2026

(30) Foreign Application Priority Data
Mar. 14, 2025 (JP) 2025-040861

(51) Int. Cl. H01M 8/0438; B60L 50/72; H01M 8/0258; H01M 8/04302; H01M 8/04992; H01M 8/10; H01M 8/1004

(52) U.S. Cl. CPC H01M 8/04388; H01M 8/0258; H01M 8/04302; H01M 8/04992; H01M 8/1004; B60L 50/72; H01M 2008/1095; H01M 2250/20

(57) ABSTRACT

A fuel cell system including a first three-axis magnetic sensor provided in an anode flow field of at least one fuel cell. A control device determines that an air-in-anode startup takes place if a flow of a corrosion current in an anode is detected based on an output of the first three-axis magnetic sensor at the time of starting up the fuel cell system.

### CROSS-REFERENCE TO RELATED APPLICATIONS

This application is based upon and claims the benefit of priority from Japanese Patent Application No. 2025-040861 filed on Mar. 14, 2025, the contents of which are incorporated herein by reference.

### BACKGROUND OF THE INVENTION

### Field of the Invention

The present disclosure relates to a fuel cell system including a fuel cell that generates electric power using a fuel gas and an oxygen-containing gas, and a control method of the fuel cell system.

### Description of the Related Art

In recent years, research and development have been conducted on fuel cells (FCs) that contribute to energy efficiency in order to ensure that more people have access to affordable, reliable, sustainable and modern energy.

JP 4971588 B2 discloses that air supplied to the cathode permeates through the electrolyte membrane to the anode during a so-called soak period in which the fuel cell stops its power generation operation (paragraph 0011 of JP 4971588 B2).

It is disclosed that when a fuel cell is started by air supplied to the cathode and hydrogen supplied to the anode in the state where air (oxygen) is present on the anode side (referred to as air-in-anode startup), the cathode of a fuel cell (also referred to as a unit cell) is exposed to a high potential, the catalytic activity of the cathode and the like decreases, and the cathode corrodes (JP 4971588 B2, paragraphs 0003 and 0027).

JP 4971588 B2 discloses that, in order to avoid the corrosion of the cathode, the electrodes are connected to each other with a resistor, and a discharge treatment is performed at the time of the air-in-anode startup, thereby preventing the cathode from being exposed to a high potential and preventing corrosion (paragraph 0027 of JP 4971588 B2)

### SUMMARY OF THE INVENTION

In JP 4971588 B2, whether or not the air-in-anode startup is performed is determined as follows. First, the fuel cell is determined to undergo the air-in-anode startup in the case where the anode is scavenged by the oxygen-containing gas at the time when the power generation operation of the fuel cell is previously stopped. Second, the fuel cell is determined to undergo the air-in-anode startup in the case where the power generation of the fuel cell is stopped for a period longer than a predetermined time (see, for example, paragraph 0006 of JP 4971588 B2).

Because JP 4971588 B2 indirectly determine whether or not the air-in-anode startup that causes corrosion of the cathode takes place, there is a desire for direct determination.

The present disclosure has the object of solving the aforementioned problem.

One aspect of the present disclosure is characterized by a fuel cell system comprising: a fuel cell stack including a plurality of fuel cells stacked in a thickness direction, each of the fuel cells including a membrane electrode assembly formed of an electrolyte membrane, and a cathode and an anode sandwiching the electrolyte membrane, and a cathode separator in which a cathode flow field is formed and an anode separator in which anode flow field is formed, the membrane electrode assembly being sandwiched by the cathode separator and the anode separator; and a first three-axis magnetic sensor provided in the anode flow field of at least one of the plurality of fuel cells, wherein upon detecting a corrosion current flowing in the anode based on an output of the first three-axis magnetic sensor at a time when the fuel cell stack is started up, the fuel cell system determines an air-in-anode startup of the fuel cell stack in which the fuel cell stack is started up in a state where air is present in the anode flow field of each of the plurality of fuel cells.

Another aspect of the present disclosure is characterized by a control method of the fuel cell system comprising a fuel cell stack including a plurality of fuel cells stacked in a thickness direction, each of the fuel cells including a membrane electrode assembly formed of an electrolyte membrane, and a cathode and an anode sandwiching the electrolyte membrane, and a cathode separator in which a cathode flow field is formed and an anode separator in which anode flow field is formed, the membrane electrode assembly being sandwiched by the cathode separator and the anode separator, the control method comprising: providing a first three-axis magnetic sensor in the anode flow field of at least one of the plurality of fuel cells; acquiring an output of the first three-axis magnetic sensor at a time when the fuel cell stack is started up; and determining, upon detecting a corrosion current flowing in the anode based on the output of the first three-axis magnetic sensor acquired at a time when the fuel cell stack is started up, an air-in-anode startup of the fuel cell stack in which the fuel cell stack is started up in a state where air is present in the anode flow field of each of the plurality of fuel cells.

According to the present disclosure, it is possible to directly determine whether or not the fuel cells are undergoing the air-in-anode startup by being supplied with hydrogen to the anode in which air (oxygen) is present, based on the presence or absence of the corrosion current.

The above and other objects, features and advantages of the present invention will become more apparent from the following description when taken in conjunction with the accompanying drawings in which a preferred embodiment of the present invention is shown by way of illustrative example.

### BRIEF DESCRIPTION OF THE DRAWINGS

FIG. 1 is a configuration diagram of an example of a fuel cell system that performs a method for controlling a fuel cell system according to an embodiment;

FIG. 2 is a schematic cross-sectional view of fuel cells;

FIG. 3 is a schematic diagram showing an example of a gas distribution and electric potential on an outlet and an inlet of a fuel cell not in operation;

FIG. 4 is a schematic diagram showing the presence of air in an anode flow field at startup and the electric potential of the fuel cell;

FIG. 5 is a functional block diagram illustrating a configuration of a corrosion current determination unit;

FIG. 6 is a flowchart for providing a description of operations of the present embodiment; and

FIG. 7A is a schematic diagram showing a state in which no corrosion current flows and FIG. 7B is a schematic diagram showing a state in which a corrosion current flows.

### DETAILED DESCRIPTION OF THE INVENTION

### Embodiment

### Configuration

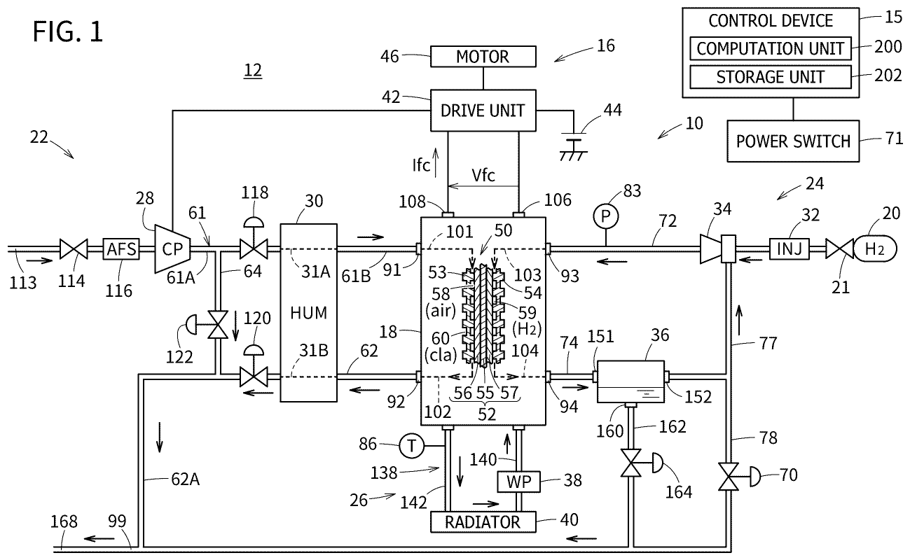

FIG. 1 is a schematic configuration diagram of a fuel cell vehicle 12, into which a fuel cell system 10 according to an embodiment of the present invention is incorporated.

The fuel cell system 10 can be incorporated into any mobile objects, such as automobiles, ships, aircrafts, and robots, other than the fuel cell vehicle 12, and also can be installed in any stationary objects such as houses and the like.

The fuel cell vehicle 12 includes a control device 15 for controlling the entire fuel cell vehicle 12, the fuel cell system 10, and an output unit 16 electrically connected to the fuel cell system 10.

The control device 15 need not necessarily be a single control device, but may be divided into two or more control devices, for example, one used for the fuel cell system 10 and one used for the output unit 16.

The fuel cell system 10 is formed of a fuel cell stack 18, a hydrogen tank 20, an oxygen-containing gas supply device 22, a fuel gas supply device 24, and a medium supply device (heat exchange medium supply device) 26.

The oxygen-containing gas supply device 22 includes a compressor (CP) 28 and a humidifier (HUM) 30.

The fuel gas supply device 24 includes a shut-off valve 21, an injector (INJ) 32, an ejector 34, and a gas-liquid separator 36. The injector 32 may be replaced with a pressure reducing valve.

The medium supply device 26 includes a medium pump (WP) 38 and a radiator 40.

The output unit 16 includes a drive unit 42, a high-voltage power storage device (battery) 44, and a motor (electrically powered device) 46. Examples of a load of the drive unit 42 includes not only the motor 46, which is a main device, but also auxiliary devices such as the compressor 28, the medium pump 38, an air conditioner (not shown), and the like. The fuel cell vehicle 12 travels due to a driving force generated by the motor 46.

The auxiliary devices are applied with a high direct current voltage of the power storage device 44 or a low direct current voltage of a low-voltage storage device (not shown). The low-voltage power storage device is charged with low-voltage power obtained by stepping down the high voltage of the power storage device 44 by a step-down converter (not shown).

In the fuel cell stack 18, a plurality of fuel cells (referred to also as power generation cells or unit cells) 50 are stacked. Each of the fuel cells 50 includes a membrane electrode assembly 52, and a pair of separators 53, 54 that sandwich the membrane electrode assembly 52.

Each of the membrane electrode assemblies 52, for example, is equipped with a polymer electrolyte membrane 55 in which a thin film of perfluorosulfonic acid is impregnated with water, and a cathode 56 and an anode 57 sandwiching the polymer electrolyte membrane 55.

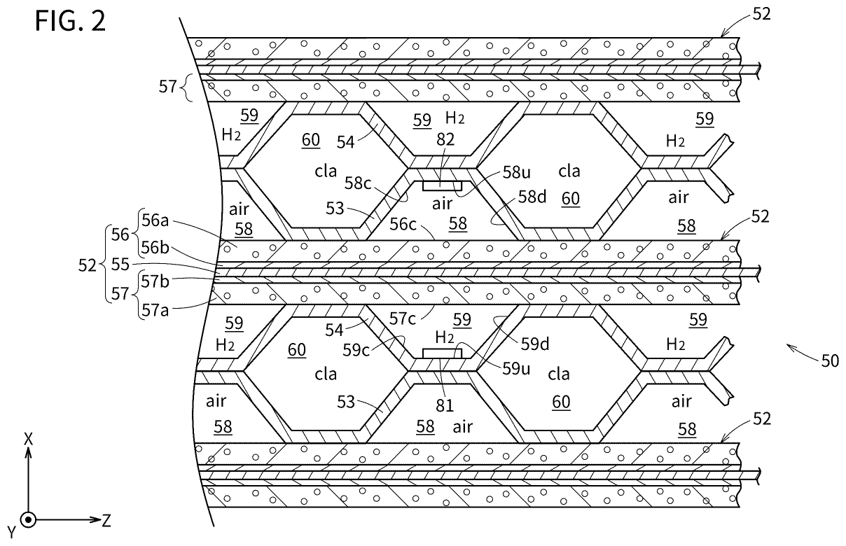

FIG. 2 is a more detailed cross-sectional view of the power generation cell 50 shown in FIG. 1.

In FIG. 2, the cathode 56 and the anode 57 respectively have a gas diffusion layers 56a, 57a, which are made of carbon paper and the like. By uniformly applying porous carbon particles, on the surface of which a platinum alloy is supported, to surfaces of the gas diffusion layers 56a, 57a, electrode catalyst layers 56b, 57b are formed on opposite surfaces of the polymer electrolyte membrane 55.

The separators 53, 54 (the cathode separator 53 and the anode separator 54) have a structure in which the cross-sectionally concave portions and the cross-sectionally convex portions are arranged in series with the membrane electrode assembly 52 interposed therebetween in a state where the phases are shifted by 180° (inverted state) in the Z direction of FIG. 2, and are stacked in a state where the phases are inverted in the X direction of FIG. 2. The tops of the cross-sectionally convex portions of the separator 53 and the bottoms of the cross-sectionally concave portions of the separator 54 are in contact with each other and sealed. The separators 53, 54 have a metal bead structure.

A heat exchange medium (denoted as “cla” in the drawings) such as a coolant can flow through a medium flow field 60 shown by a hexagonal cross section formed by the separators 53, 54 stacked.

As shown in FIG. 1, on the side of the one separator 53 that faces the membrane electrode assembly 52, a cathode flow field (an oxygen-containing gas flow field) 58 in communication with an oxygen-containing gas supply passage 101 and an oxygen-containing gas discharge passage 102 is formed (also refer to FIG. 2).

On the side of the other separator 54 that faces the membrane electrode assembly 52, an anode flow field (a fuel gas flow field) 59 in communication with the fuel gas supply passage 103 and fuel gas discharge passage 104 is formed (also refer to FIG. 2).

Fuel gas (H₂) flows through the anode flow field 59 formed by the anode 57 and the separator 54 stacked on the anode 57 (FIGS. 1 and 2).

Oxygen-containing gas (air) flows through the cathode flow field 58 formed by the cathode 56 and the separator 53 stacked on the cathode 56 (FIGS. 1 and 2).

In the anode 57, by the fuel gas being supplied, hydrogen ions are generated from hydrogen molecules by electrode reactions caused by the electrode catalyst layer 57b, and the hydrogen ions pass through the polymer electrolyte membrane 55 and then move to the cathode 56, while electrons are released from hydrogen molecules.

Electrons released from hydrogen molecules from the negative terminal 106 (FIG. 1) move through the loads such as the drive unit 42, the motor 46, and the like to the cathode 56 via the positive terminal 108.

At the cathode 56, by the action of the electrode catalyst layer 56b, hydrogen ions and electrons, and oxygen contained in the supplied oxygen-containing gas react to produce water.

The generated power (generated voltage Vfc×generated current Ifc) generated between the positive terminal 108 and the negative terminal 106 is supplied to the motor 46, which is the main device, the compressor 28, which is an auxiliary device, and the like, via the drive unit 42.

The compressor 28 is configured by a mechanical supercharger or the like driven by a compressor motor (not shown) to which electric power of the power storage device 44 is supplied through the drive unit 42, and has functions such as sucking outside air (atmosphere, air) from an outside air intake hole 113, pressurizing it, and supplying it to the fuel cell stack 18 through the humidifier 30.

The humidifier 30 has a flow path 31A and a flow path 31B. Air (oxygen-containing gas) compressed, heated to a high temperature and dried by the compressor 28 flows through the flow path 31A. The exhaust gas discharged from the oxygen-containing gas discharge passage 102 of the fuel cell stack 18 flows through the flow path 31B.

The humidifier 30 has a function of humidifying the oxygen-containing gas supplied from the compressor 28. More specifically, the humidifier 30 causes water contained within the exhaust gas (off-gas) flowing through the flow path 31B to move via an internal porous membrane to the gas (the oxygen-containing gas) flowing through the flow path 31A, and thereby humidifies the gas to be supplied, and supplies the humidified oxygen-containing gas to the fuel cell stack 18 through an oxygen-containing gas inlet 91.

A shut-off valve 114, an air flow sensor (AFS: flow rate sensor) 116, the compressor 28, an input side stop valve 118, and the humidifier 30 are provided on the oxygen-containing gas supply flow path 61 (including oxygen-containing gas supply flow paths 61A, 61B) extending from the outside air intake hole 113 to the oxygen-containing gas inlet 91 in order from the outside air intake hole 113. The flow paths such as the oxygen-containing gas supply flow path 61 drawn by double lines are formed by pipes (the same applies to the following description).

The shut-off valve 114 is opened to allow and close to shut off intake of the air into the oxygen-containing gas supply flow path 61.

The air flow sensor 116 measures the mass flow rate of the oxygen-containing gas supplied to the fuel cell stack 18 through the compressor 28.

The input side stop valve 118 opens and closes the oxygen-containing gas supply flow path 61B.

The humidifier 30 and a discharge side stop valve 120 that also functions as a back pressure valve are disposed in this order from the oxygen-containing off-gas outlet 92 on the oxygen-containing off-gas flow path 62 in communication with the oxygen-containing gas discharge passage 102 via the oxygen-containing off-gas outlet 92.

A bypass channel 64 is provided between a suction inlet of the input side stop valve 118 and a discharge outlet of the discharge side stop valve 120 to allow the oxygen-containing gas supply flow path 61 and the oxygen-containing off-gas flow path 62 to communicate with each other. The bypass channel 64 is provided with a bypass valve 122 that opens and closes the bypass channel 64. The bypass valve 122 adjusts the flow rate of the oxygen-containing gas bypassing the fuel cell stack 18.

A merging flow path between the bypass channel 64 and the oxygen-containing off-gas flow path 62 communicates with a discharge flow path 62A.

The hydrogen tank 20 is a container including a solenoid shut-off valve 21, and compresses highly pure hydrogen under high pressure, and stores the compressed hydrogen.

The fuel gas discharged from the hydrogen tank 20 passes through the shut-off valve 21, the injector 32 and the ejector 34 that are provided in a fuel gas supply flow path 72, and is supplied to an inlet of the anode flow field 59 via a fuel gas inlet 93 and a fuel gas supply passage 103 of the fuel cell stack 18. In the fuel gas supply flow path 72 near the fuel gas inlet 93, a pressure sensor 83 is provided that detects (measures, acquires) an inlet pressure as an anode inlet pressure Pin of the fuel gas in the fuel gas flow field 59.

An outlet of the anode flow field 59 is in communication with an inlet 151 of the gas-liquid separator 36 through the fuel gas discharge passage 104, a fuel off-gas outlet 94, and a fuel off-gas flow path 74, and further, the fuel off-gas, which is a hydrogen containing gas, is supplied to the gas-liquid separator 36 from the anode flow field 59.

The gas liquid separator 36 separates the fuel off-gas into gaseous components and liquid components (water). The gaseous components of the fuel off-gas (fuel exhaust gas) are discharged from a gas discharge hole 152 of the gas-liquid separator 36 and supplied to an intake of the ejector 34 through a circulation flow path 77 while the purge valve 70 is in a closed state.

On the other hand, when the purge valve 70 is opened, the fuel off-gas is mixed with the exhaust gas discharged from the discharge flow path 62A via the purge flow path 78, and is discharged to the outside (atmosphere) through the discharge flow path 99 and the exhaust gas hole 168.

The liquid components of the fuel off-gas are discharged from a liquid discharge port 160 of the gas-liquid separator 36 to a drain flow path 162 in which a drain valve 164 is provided, and mixed with the discharged gas that is discharged from the discharge flow path 62A, and then discharged to the outside (air) through a discharge flow path 99 and the exhaust gas hole 168.

As described above, the fuel gas within the liquid water and the fuel off-gas discharged from the drain flow path 162 or the purge flow path 78 is diluted in the discharge flow path 99 due to the oxygen-containing off-gas from the discharge flow path 62A, and is discharged from the exhaust gas hole 168 to the exterior (into the atmosphere) of the fuel cell vehicle 12.

A medium supply device 26 of a fuel cell system 10 includes a medium pipe 138 through which a heat exchange medium flows. A medium supply flow path 140 and a medium discharge flow path 142 are formed by the medium pipe 138. The heat exchange medium is supplied through the medium supply flow path 140 to the medium flow field 60 inside the fuel cell stack 18 (see FIG. 2), and the heat exchange medium that has flowed through the medium flow field 60 of the fuel cell stack 18 is discharged to the medium discharge flow path 142.

The radiator 40 is connected between the medium discharge flow path 142 and the medium supply flow path 140. The radiator 40 cools the heat exchange medium. The medium supply flow path 140 is provided with the medium pump 38. The medium pump 38 causes the heat exchange medium to circulate inside a medium circulation circuit. The medium supply flow path 140, an internal medium flow field 60 of the fuel cell stack 18 (see FIG. 2), the medium discharge flow path 142, and the radiator 40 are included in the medium circulation circuit.

The temperature sensor (temperature acquiring unit) 86 is provided in the medium discharge flow path 142. The temperature of the heat exchange medium (medium outlet temperature) detected by the temperature sensor 86 is regarded as the (internal) temperature of the fuel cell stack 18.

### Mechanism of Fuel Cell Output Decrease by High Potential

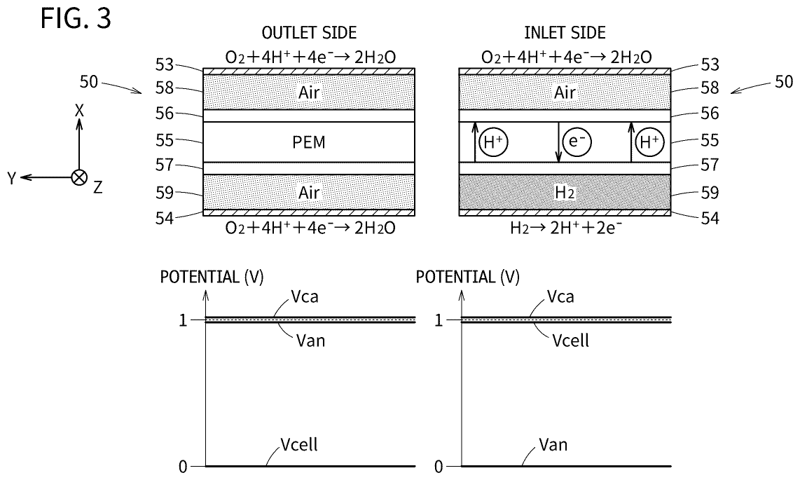

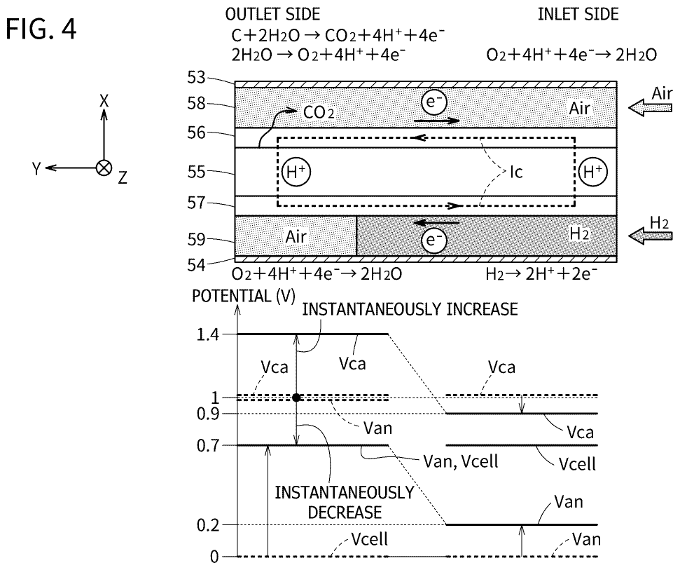

Here, a mechanism by which the fuel cell output decreases due to high potential will be described. FIGS. 3 and 4 are schematic diagrams showing the mechanism by which the fuel cell output decreases due to deterioration of the cathode 56 and the like, which occurs when the cathode 56 is brought into a high potential at the air-in-anode startup in which the fuel cell stack 18 is started up with air existing in the anode flow field 59.

FIG. 3 is a schematic diagram showing an example of a gas distribution and electric potential on an outlet and an inlet of a fuel cell (referred to as unit cell or power generation cell) 50 not in operation (standby time before startup).

The power generation cell 50 has a structure in which the cathode 56 and the cathode flow field 58 including the catalyst are stacked on one surface of the electrolyte membrane (PEM) 55, and the anode 57 and the anode flow field 59 containing the catalyst are stacked on the other surface of the electrolyte membrane 55.

The cathode flow field 58 to which air is supplied during power generation is formed by the separator 53. The anode flow field 59 to which hydrogen is supplied during power generation is formed by the separator 54.

At the time when the fuel cell is not in operation before startup, both the cathode flow field 58 and the anode flow field 59 are filled with air (AIR) on the outlet side of the power generation cell 50.

In this case, the reaction represented by Chemical Equation(1) in which oxygen molecules, hydrogen ions, and electrons become water molecules may occur at the cathode 56 and the anode 57.

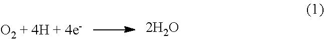

Therefore, the potential (cathode potential) Vca of the cathode 56 and the potential (anode potential) of the anode 57 on the outlet side are about 1 [V], respectively, and the cell voltage (inter-cell voltage) Vcell (Vcell=Vca−Van) is 0 [V].

On the other hand, on the inlet side of the power generation cell 50 at startup, the cathode flow field 58 is filled with air, and the anode flow field 59 is filled with fuel gas (H₂).

In this case, the reaction represented by Chemical Equation (1) may occur at the cathode 56. On the other hand, at the anode 57, a reaction in which hydrogen is divided into protons and electrons as shown in Chemical Equation(2) may occur.

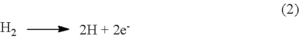

Therefore, the cathode potential Vca on the inlet side becomes about 1 [V] equal to the open circuit voltage OCV, the anode potential Van on the inlet side becomes 0 [V], and the cell voltage Vcell (Vcell=Vca−Van) becomes 1 [V].

FIG. 4 is a schematic diagram showing the presence of air in the anode flow field 59 at startup and the electric potential of the fuel cell.

At startup, the supply of the oxygen-containing gas (air) to the cathode flow field 58 and the supply of the fuel gas (hydrogen) to the anode flow field 59, which are indicated by the arrows, respectively, from the inlet sides are initiated. As a result, the anode potential Van instantaneously decreases from 1.0 [V] to 0.7 [V] on the outlet side where air is present, while the cathode potential Vca on the outlet side instantaneously increases from 1 [V] to 1.4 [V] in order to maintain the cell voltage Vcell.

Therefore, the cathode 56 is exposed to a high voltage equal to or higher than 1 [V], and a potential difference is generated between the cathode 56 and the anode 57, so that a corrosion current Ic flows through the cathode 56 and the anode 57 via carbon as indicated by the broken line with arrows in the upper part of FIG. 4.

More specifically, on the outlet side of the cathode flow field 58 of the cathode 56, the oxidation reaction of carbon shown in Chemical Equation (3) occurs vigorously together with the oxidation reaction of water, and the emitted electrons flow as a corrosion current Ic through the cathode 56 in the surface direction due to the potential difference inside the electrode. In other words, the corrosion current Ic flows through the cathode 56 in the surface direction. The high potential corrodes carbon supported by the catalyst, and platinum is eluted and the effective surface area is reduced, thereby degrading the power generation performance (power generation voltage) of the fuel cell stack 18.

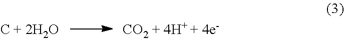

In this case, the emitted electrons flow through the electrode surface in the surface direction due to the potential difference in the electrode also on the anode 57 side, and therefore, the corrosion current Ic flows through carbon as a medium also on the anode 57 side. In other words, the corrosion current Ic flows through the cathode 56 in the surface direction. It is understood that both the corrosion currents Ic form a circulating current.

In this way, a circulating current of the corrosion current Ic flows at startup in the case where air is present on the anode outlet side.

Therefore, an oxidation reaction of hydrogen occurs on the anode inlet side, a reduction reaction of oxygen occurs on the anode outlet side, and an oxidation reaction of water occurs on the cathode outlet side, so that the potential of the cathode 56 rises. As a result, every time the fuel cell system 10 is started, the oxidation reaction of water and the oxidation reaction of carbon in Chemical Equation (3) occur vigorously in the vicinity of the cathode outlet repeatedly, so that the cell characteristics deteriorate, and the output of the fuel cell stack 18 decreases.

The above is the description of the mechanism by which the fuel cell output decreases due to deterioration of the cathode 56 and the like, which occurs when the cathode 56 is brought into a high potential at the air-in-anode startup in which the fuel cell stack 18 is started up with air existing in the anode flow field 59.

### Premise for Determination of Air-In-Anode Startup

Next, a premise for determining whether or not air-in-anode startup in which a corrosion current Ic flows at startup takes place will be described.

As shown in FIG. 2, the anode flow field 59 and the cathode flow field 58, which extend in the Y direction with the membrane electrode assembly 52 interposed therebetween, are formed in a channel shape (trapezoidal in cross section).

The anode flow field 59 is formed by being surrounded by an anode surface (bottom surface) 57c of the anode 57, inner wall surfaces 59c, 59d extending from the anode surface 57c inward in a direction away from the anode surface 57c, and an upper surface 59u connecting the inner wall surfaces 59c, 59d.

Similarly, the cathode flow field 58 is formed by a cathode surface (bottom surface) 56c of the cathode 56, inner wall surfaces 58c, 58d extending from the cathode surface 56c inward in a direction away from the cathode surface 56c, and an upper surface 58u connecting the inner wall surfaces 58c, 58d.

A first three-axis magnetic sensor 81 is arranged on the upper surface 59u facing the anode surface 57c, and a second three axis magnetic sensor 82 is arranged on the upper surface 58u facing the cathode surface 56c. The first and second three-axis magnetic sensors 81, 82 are disposed plane-symmetrically with respect to the electrolyte membrane 55.

As long as the first and second three-axis magnetic sensors 81, 82 are plane-symmetrical with respect to the electrolytic membrane 55, the first and second three-axis magnetic sensors 81, 82 may be disposed on the inner wall surfaces 59c, 58c, or on the inner wall surfaces 59d, 58d.

The first and second three-axis magnetic sensors 81, 82 may be disposed in spaces separated from the anode surface 57c and the cathode surface 56c, respectively, so as to be plane-symmetrical with respect to the electrolytic membrane 55. In the case of arranging the three-axis magnetic sensors 81, 82 in such spaces, for example, support bases (not shown) may be erected on the upper surface 59u of the separator 54 and the upper surface 58u of the separator 53.

As described above, the plane-symmetrical arrangement facilitates processing of the output signals of the first and second three-axis magnetic sensors 81, 82. Even if the arrangement is not plane-symmetrical, the output signals can be processed by grasping the arrangement positions in advance.

At least one set of the first and second three-axis magnetic sensors 81, 82 may be disposed on the upper surfaces 59u, 58u of the separators 53, 54 facing each other with the membrane electrode assembly 52 interposed therebetween, in the anode flow field 59 and the cathode flow field 58 of at least one fuel cell 50 forming the fuel cell stack 18.

A plurality of sets of the first and second three-axis magnetic sensors 81, 82 may be disposed for at least one fuel cell 50, one set may be disposed for each set of a plurality of fuel cells 50, or one set may be disposed for each fuel cell 50.

Only one of the first and second three-axis magnetic sensors 81, 82 may be disposed. In the case where only one of them is disposed, it is preferable to dispose the first three-axis magnetic sensor 81 on one of the anode surface 57c, the inner wall surfaces 59c, 59d, and the upper surface 59u in the anode flow field 59, or in the space within the anode flow field 59 where corrosion caused by the corrosion current is small.

In the following description, as an example, a configuration will be described in which the first three-axis magnetic sensor 81 and the second three-axis magnetic sensor 82 are disposed, respectively, on the upper surface 59u facing the anode surface 57c and on the upper surface 58u facing the cathode surface 56c, the two surfaces facing each other across the electrolyte membrane 55 interposed therebetween, in plane symmetry with respect to the electrolyte membrane 55.

The above is the description of the configuration that is a premise for determining whether or not the air-in-anode startup in which a corrosion current Ic flows at startup takes place.

### Description of Control Device 15

The actuators such as the compressor 28 and the injector 32 of the fuel cell system 10 shown in FIG. 1 are integrally controlled by the control device 15.

The input side stop valve 118, the discharge side stop valve 120, the bypass valve 122, the purge valve 70, and the drain valve 164, except for the shut-off valves 21, 114 which are on-off valves whose opening and closing are controlled by the control device 15, are flow rate adjustment valves the valve openings of which are controlled by the control device 15, the duty thereof may also be controlled using electromagnetic control type ON/OFF valves.

The control device 15 is an electronic device (computer) provided in the fuel cell system 10. The control device 15 includes a computation unit (processing unit) 200, a storage unit 202, a display unit, and an operation unit.

The computation unit 200 may be constituted by a processor such as a CPU (Central Processing Unit), a GPU (Graphics Processing Unit), or the like. More specifically, the computation unit 200 can be configured by a processing circuit (processing circuitry).

The computation unit 200 comprises a determination unit and a control unit. The determination unit and the control unit can be realized by programs, which are stored in the storage unit 202, being executed by the computation unit 200.

Moreover, it should be noted that at least a portion of the determination unit and the control unit may be implemented by an integrated circuit such as an ASIC (Application Specific Integrated Circuit), or a FPGA (Field-Programmable Gate Array). Further, at least a portion of the determination unit and the control unit may be constituted by an electronic circuit including a discrete device.

The storage unit 202 may be made up of a volatile memory (not shown), and a non-volatile memory (not shown). Examples of the volatile memory includes a RAM (Random Access Memory), etc. Such a volatile memory is used as a working memory of the processor, and temporarily stores data necessary for performing processing or calculations. Examples of the non-volatile memory includes a ROM (Read only memory), a flash memory, etc. The non-volatile memory is used as a storage memory, and serves to store a program, a table, a map, and the like. At least part of the storage unit 202 may be provided in the processor, the integrated circuit, etc. as described above.

The computation unit 200 of the control device 15, by executing calculations in accordance with the program, perform controls such as a control of operations of the fuel cell vehicle 12 and the fuel cell system 10.

### Configuration of Corrosion Current Determination Unit

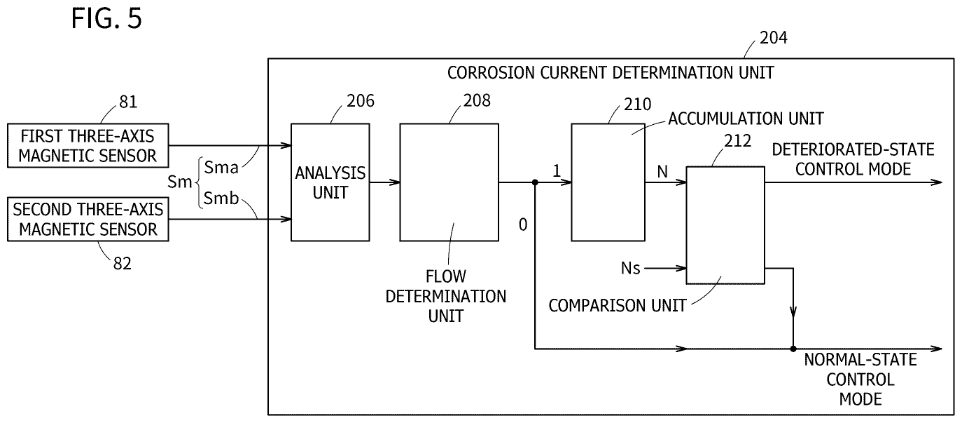

FIG. 5 is a functional block diagram showing a configuration of a corrosion current determination unit 204, which is a part of the functions of the control device 15 achieved by the computation unit 200 executing calculations in accordance with the program.

The corrosion current determination unit 204 acquires and analyzes the magnetic field signals Sm (Sma, Smb) obtained by simultaneously detecting magnetic field strengths in the X-axis direction, the Y-axis direction, and the Z-axis direction (see FIGS. 2 to 4) of the first and second three-axis magnetic sensors 81, 82, and determines whether the corrosion current Ic flows.

The corrosion current determination unit 204 includes an analysis unit 206 that acquires the magnetic field signals Sma, Smb detected by the first and second three-axis magnetic sensors 81 and 82, a flow determination unit 208, an accumulation unit 210, and a comparison unit 212.

The analysis unit 206 calculates a vector of a magnetic field generated by the corrosion current Ic based on magnetic field signals Sm (Sma, Smb) obtained from the respective X-, Y-, and Z-axis magnetoresistive element bridges (not shown) included in the first and second three-axis magnetic sensors 81, 82. The vector of the magnetic field has a specific direction and magnitude with respect to the corrosion current Ic. The analysis unit 206 calculates the corrosion current Ic (a current flowing through the cathode 56 and the anode 57 in the Z direction).

The flow determination unit 208 determines whether or not the corrosion current Ic is flowing (flowing=1, not flowing=0) based on the calculation result of the analysis unit 206.

The accumulation unit 210 calculates the number N of air-in-anode startups by accumulating the flow determination results of “flowing=1” and transmits the number N to the comparison input terminal of the comparison unit 212.

The comparison unit 212 compares the number N of air-in-anode startups transmitted to the comparison input terminal with a predetermined specified number Ns set as the reference input.

When the number N of air-in-anode startups is equal to or greater than the specified number Ns (N≥Ns), the control device 15 controls the fuel cell system 10 in a deteriorated-state control mode.

On the other hand, when the number N of air-in-anode startups is less than the specified number Ns (N<Ns) or when the flow determination result by the flow determination unit 208 is “not flowing=0”, the control device 15 controls the fuel cell system 10 in the normal-state control mode.

### Operation

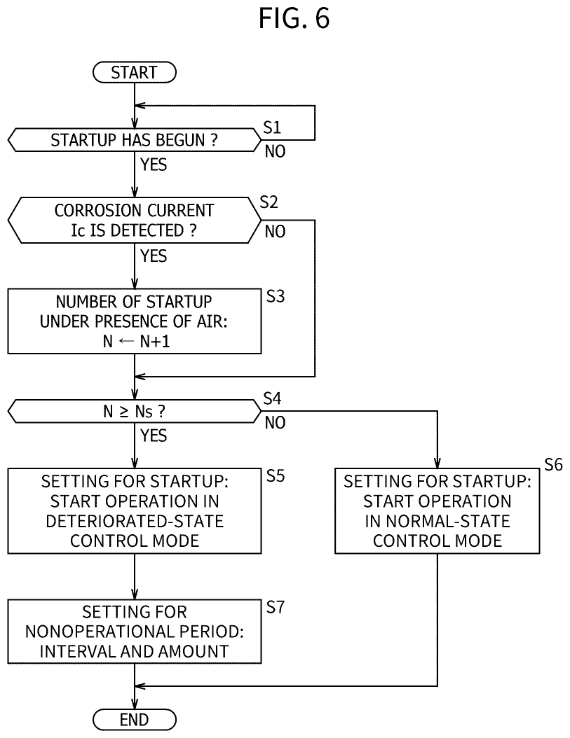

Next, operation of the above-described embodiment, basically having the above structure, will be described in detail based on a flow chart shown in FIG. 6.

In step S1, when the control device 15 affirmatively determines that a startup operation has begun in response to the power switch 71 being turned from the OFF state to the ON state (step S1: YES), the control device 15 activates the compressor 28 to supply the oxygen-containing gas to the cathode flow fields 58 of the fuel cells 50 of the fuel cell stack 18, opens the shut-off valve 21 to drive the injector 32, and supplies the fuel gas from the hydrogen tank 20 to the anode flow fields 59 of the fuel cells 50 through the injector 32 and the ejector 34, whereupon the process advances to step S2.

In step S2, the control device 15 determines whether or not the corrosion current Ic has been detected. The analysis unit 206 and the flow determination unit 208 of the corrosion current determination unit 204 acquire and analyze the magnetic field signals Sm (Sma, Smb) from the first and second three-axis magnetic sensors 81, 82, and determine whether or not the corrosion current Ic is detected.

A magnetic field is formed around the anode 57 and the cathode 56 through which the corrosion current Ic flows, in accordance with Ampere's law. This magnetic field has a specific direction with respect to the flow direction of the corrosion current Ic.

The magnetic field signals Sm obtained by the first and second three-axis magnetic sensors 81, 82 include the magnetic field strengths along the three axes X, Y, and Z. In this manner, the vector of the magnetic field generated by the corrosion current Ic is acquired as data.

By analyzing the data of the measured magnetic field, the direction (Y direction) in which the corrosion current Ic flows can be specified. The magnitude of the corrosion current Ic can also be estimated from the strength of the magnetic field.

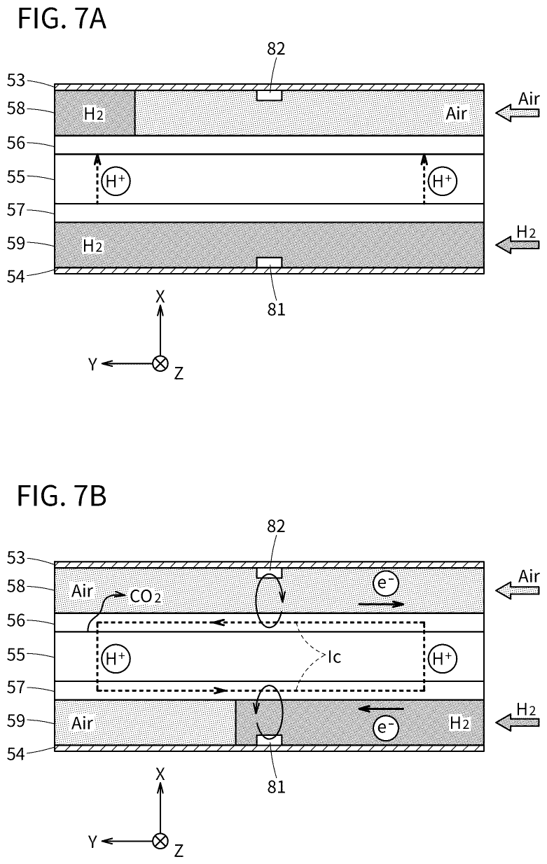

FIG. 7A is a schematic diagram showing a state in which no corrosion current Ic flows.

Since a normal power generation is performed by the fuel gas (hydrogen H₂) supplied to the anode flow field 59 and the oxygen-containing gas O₂ supplied to the cathode flow field 58, no magnetic field that can be detected by the first and second three-axis magnetic sensors 81, 82 is generated. Therefore, the corrosion current Ic does not flow through the anode 57 and through the cathode 56. In this case, the analysis unit 206 analyzes that the corrosion current Ic is not generated.

FIG. 7B is a schematic diagram showing a state in which a corrosion current Ic flows. By detecting the magnetic field being generated, the generation of the corrosion current Ic is analyzed by the analysis unit 206.

Based on the analysis result of the analysis unit 206, the flow determination unit 208 supplies a flag (determination result) of “flowing=1” (step S2: YES) or “not flowing=0” (step S2: NO) to the accumulation unit 210.

Based on the flag of “flowing=1” of the corrosion current Ic, the accumulation unit 210 updates (accumulates) the number N of air-in-anode startups by 1 (N←N+1) in step S3, whereupon the process advances to step S4.

In the case of the flag of “not flowing=0” of the corrosion current Ic, the accumulation unit 210 advances the process to step S4 without updating the number N of air-in-anode startups.

In step S4, the comparison unit 212 determines whether the number N of air-in-anode startups is equal to or greater than the specified number Ns (N≥Ns) at every startup.

In the comparison unit 212, when N≥Ns is established, that is, when the number N of air-in-anode startups is equal to or larger than the specified number Ns, the control device 15 advances the process to step S5.

On the other hand, when N<Ns at comparison unit 212, the number N of air-in-anode startups has not reached the specified number Ns, and thus the control device 15 advances the process to step S6.

In step S6, the control device 15 starts operation using the setting of the normal-state control mode as a startup setting.

In step S5, the control device 15 starts operation using the setting of the deteriorated-state control mode as a startup setting. In the deteriorated-state control mode, as described in paragraph 0027 of JP 4971588 B2, for example, before being connected to the motor 46, the compressor 28, and the power storage device 44 through the drive unit 42, the fuel cell stack 18 is connected to a resistor (not shown: reference numeral 31 in FIG. 1 of JP 4971588 B2) of an auxiliary circuit (not shown: reference numeral 30 in FIG. 1 of JP 4971588 B2)provided between a positive terminal 108 and a negative terminal 106 of the fuel cell stack 18. As a result, the high potential state of the fuel cell stack 18 is eliminated owing to discharge at the resistor. As a result, the power generation cell 50 is not exposed to a high potential for a long time, and the cathode 56 and the anode 57 can be prevented from corroding. When the corrosion current Ic is no longer detected, the operation in the normal mode is performed, whereupon the process advances to step S7.

In step S7, the control device 15 sets an operation for the period during which the fuel cells are not in operation after the power switch 71 is turned from the ON state to the OFF state, whereupon the process comes to an end. In the step S7, as the operation for the next and subsequent periods during which the fuel cells are not in operation, the fuel gas to be fed intermittently in the process executed by the control device 15 while the fuel cells are not in operation (referred to as anode purging while the fuel cells are not in operation)is increased, or the intermittent feeding time (interval) between the anode purging is shortened. This can prevent the outlet side of the anode flow field 59 from being placed in an air atmosphere while the fuel cells are not in operation.

When the number N of air-in-anode startups exceeds the specified number Ns once, the deterioration determination due to the startups under the presence of air is confirmed, and the startup operation is performed in the deteriorated-state control mode. Thereafter, the air-in-anode determination process according to the flowchart shown in FIG. 6 is no longer necessary, but may be performed.

### Supplementary Note

In relation to the above-described disclosure, the following supplementary notes are further disclosed.

### Supplementary Note 1

The fuel cell system (10) according to the present disclosure comprising: the fuel cell stack (18) including the plurality of fuel cells (50) stacked in a thickness direction, each of the fuel cells including the membrane electrode assembly (52) formed of the electrolyte membrane (55), and the cathode (56) and the anode (57) sandwiching the electrolyte membrane, and the cathode separator (53) in which the cathode flow field (58) is formed and the anode separator (54) in which anode flow field (59)is formed, the membrane electrode assembly being sandwiched by the cathode separator and the anode separator; and the first three-axis magnetic sensor (81) provided in the anode flow field of at least one of the plurality of fuel cells, wherein upon detecting a corrosion current flowing in the anode based on an output of the first three-axis magnetic sensor at the time when the fuel cell stack is started up, the fuel cell system determines an air-in-anode startup of the fuel cell stack in which the fuel cell stack is started up in a state where air is present in the anode flow field of each of the plurality of fuel cells.

In accordance with such a configuration, it is possible to directly determine whether or not the fuel cells are undergoing the air-in-anode startup by being supplied with hydrogen to the anode in which air (oxygen) is present, based on the presence or absence of the corrosion current.

### Supplementary Note 2

In the fuel cell system according to Supplementary Note 1, the fuel cell system further comprises the second three-axis magnetic sensor (82) provided in the cathode flow field of the at least one of the plurality of fuel cells, wherein upon detecting a corrosion current circulating in the anode and the cathode based on outputs of the first and second three-axis magnetic sensors at the time when the fuel cell stack is started up, the fuel cell system may determine the air-in-anode startup of the fuel cell stack.

According to such a configuration, it is possible to more clearly determine whether or not the fuel cell stack is undergoing the air-in-anode startup by detecting whether or not the corrosion current circulating in the anode and the cathode is generated based on the outputs of the first and second three-axis magnetic sensors at the time of startup of the fuel cell stack.

### Supplementary Note 3

In the fuel cell system according to Supplementary Note 2, the first and second three-axis magnetic sensors may be disposed plane-symmetrically with respect to the electrolyte membrane. This arrangement facilitates determination of the mounting positions of the first and second three-axis magnetic sensors.

### Supplementary Note 4

In the fuel cell system according to Supplementary Note 1 or 2, the fuel cell system accumulates a number of the air-in-anode startups every time the air-in-anode startup of the fuel cell stack is determined, determines whether an accumulated number of the air-in-anode startups is equal to or greater than a specified number, and supplies a fuel gas intermittently to the anode flow field at shorter intervals in next and subsequent periods in which the fuel cell stack is not in operation in a case where the accumulated number of the air-in-anode startups is equal to or greater than the specified number.

In this way, once the air-in-anode startup is confirmed, the next air-in-anode startup can be suppressed from taking place by supplying the fuel gas intermittently at shorter intervals in the next and subsequent periods in which the fuel cell stack is not in operation, and thus the fuel cells can be appropriately controlled.

### Supplementary Note 5

In the fuel cell system according to Supplementary Note 1 or 2, the fuel cell system accumulates a number of the air-in-anode startups every time the air-in-anode startup of the fuel cell stack is determined, determines whether an accumulated number of the air-in-anode startups is equal to or greater than a specified number, and supplies a fuel gas intermittently to the anode flow field in a greater amount in next and subsequent periods in which the fuel cell stack is not in operation in a case where the accumulated number of the air-in-anode startups is equal to or greater than the specified number.

In this way, once the air-in-anode startup is confirmed, the next air-in-anode startup can be suppressed from taking place by supplying the fuel gas intermittently in a greater amount in the next and subsequent periods in which the fuel cell stack is not in operation, and thus the fuel cells can be appropriately controlled.

### Supplementary Note 6

The control method according to the present disclosure of the fuel cell system comprising the fuel cell stack including the plurality of fuel cells stacked in the thickness direction, each of the fuel cells including the membrane electrode assembly formed of the electrolyte membrane, and the cathode and the anode sandwiching the electrolyte membrane, and the cathode separator in which the cathode flow field is formed and the anode separator in which anode flow field is formed, the membrane electrode assembly being sandwiched by the cathode separator and the anode separator, the control method comprising: providing the first three-axis magnetic sensor in the anode flow field of the least one of the plurality of fuel cells; acquiring an output of the first three-axis magnetic sensor at the time when the fuel cell stack is started up; and determining, upon detecting the corrosion current flowing in the anode based on the acquired output of the first three-axis magnetic sensor, the air-in-anode startup of the fuel cell stack in which the fuel cell stack is started up in the state where air is present in the anode flow field of each of the plurality of fuel cells.

According to such a method, it is possible to directly determine whether or not the fuel cell is started up by being supplied with hydrogen to the anode in which air (oxygen) is present, based on the presence or absence of the corrosion current.

### Supplementary Note 7

In the control method for a fuel cell system according to Supplementary Note 6, the control method may further comprise providing the second three-axis magnetic sensor in the cathode flow field of the at least one of the plurality of fuel cells, wherein acquiring the output of the first three-axis magnetic sensor may include acquiring an output of the second three-axis magnetic sensor at the time when the fuel cell stack is started up, and in determining, the anode air startup is determined by detecting a corrosion current circulating in the anode and the cathode based on the acquired outputs of the first and second three-axis magnetic sensors.

According to such a configuration, it is possible to more clearly determine whether or not the fuel cell stack is undergoing the air-in-anode startup by detecting whether or not the corrosion current circulating in the anode and the cathode is generated based on the outputs of the first and second three-axis magnetic sensors at the time of startup of the fuel cell stack.

The present disclosure is not necessarily limited to the individual embodiments described above. These embodiments can be subjected to various additions, substitutions, modifications, partial deletions, and the like, within a range that does not depart from the essence and gist of the present disclosure, or alternatively, the spirit and gist of the present disclosure as derived from the contents described in the claims and their equivalents. Further, these embodiments can also be implemented in combination. For example, in the above-described embodiments, the order of each of the operations and the order of each of the processes are shown merely as examples, and the present invention is not necessarily limited to these examples. The same applies also in the case that numerical values or mathematical expressions are used in the description of the aforementioned embodiments.

1. A fuel cell system comprising:
a fuel cell stack including a plurality of fuel cells stacked in a thickness direction, each of the fuel cells including a membrane electrode assembly formed of an electrolyte membrane, and a cathode and an anode sandwiching the electrolyte membrane, and a cathode separator in which a cathode flow field is formed and an anode separator in which anode flow field is formed, the membrane electrode assembly being sandwiched by the cathode separator and the anode separator; and
a first three-axis magnetic sensor provided in the anode flow field of at least one of the plurality of fuel cells,
one or more processors that execute computer-executable instructions stored in a memory, wherein
the one or more processors execute the computer-executable instructions to cause the fuel cell system to:
determine, upon detecting a corrosion current flowing in the anode based on an output of the first three-axis magnetic sensor at a time when the fuel cell stack is started up, an air-in-anode startup of the fuel cell stack in which the fuel cell stack is started up in a state where air is present in the anode flow field of each of the plurality of fuel cells.

2. The fuel cell system according to claim 1, further comprising:
a second three-axis magnetic sensor provided in the cathode flow field of the at least one of the plurality of fuel cells, wherein
the one or more processors execute the computer-executable instructions to cause the fuel cell system to:
determine, upon detecting a corrosion current circulating in the anode and the cathode based on outputs of the first three-axis magnetic sensor and the second three-axis magnetic sensor at the time when the fuel cell stack is started up, the air-in-anode startup of the fuel cell stack.

3. The fuel cell system according to claim 2, wherein the first three-axis magnetic sensor and the second three-axis magnetic sensor are disposed plane-symmetrically with respect to the electrolyte membrane.

4. The fuel cell system according to claim 1, wherein
the one or more processors execute the computer-executable instructions to cause the fuel cell system to:
accumulate a number of air-in-anode startups every time the air-in-anode startup of the fuel cell stack is determined;
determine whether an accumulated number of the air-in-anode startups is equal to or greater than a specified number; and
in a case where the accumulated number of air-in-anode startups is equal to or greater than the specified number, supply the fuel gas intermittently to the anode flow field at shorter intervals in next and subsequent periods in which the fuel cell stack is not in operation.

5. The fuel cell system according to claim 1, wherein
the one or more processors execute the computer-executable instructions to cause the fuel cell system to:
accumulate a number of air-in-anode startups every time the air-in-anode startup of the fuel cell stack is determined;
determine whether an accumulated number of air-in-anode startups is equal to or greater than a specified number; and
in a case where the accumulated number of air-in-anode startups is equal to or greater than the specified number, supply the fuel gas intermittently to the anode flow field in a greater amount in next and subsequent periods in which the fuel cell stack is not in operation.

6. A control method of the fuel cell system comprising a fuel cell stack including a plurality of fuel cells stacked in a thickness direction, each of the fuel cells including a membrane electrode assembly formed of an electrolyte membrane, and a cathode and an anode sandwiching the electrolyte membrane, and a cathode separator in which a cathode flow field is formed and an anode separator in which anode flow field is formed, the membrane electrode assembly being sandwiched by the cathode separator and the anode separator;
The control method comprising:
providing a first three-axis magnetic sensor provided in the anode flow field of at least one of the plurality of fuel cells,
acquiring an output of the first three-axis magnetic sensor at a time when the fuel cell stack is started up; and
determining, upon detecting a corrosion current flowing in the anode based on the acquired output of the first three-axis magnetic sensor, an air-in-anode startup of the fuel cell stack in which the fuel cell stack is started up in a state where air is present in the anode flow field of each of the plurality of fuel cells.

7. The control method of the fuel cell system according to claim 6, further comprising:
providing a second three-axis magnetic sensor in the cathode flow field of the at least one of the plurality of fuel cells,
wherein in the acquiring of the output of the first three-axis magnetic sensor, acquiring an output of the second three-axis magnetic sensor; and
in the determining of the anode-in-air startup, detecting a corrosion current circulating in the anode and the cathode based on the output of the first three-axis magnetic sensor and the output of the second three-axis magnetic sensor.
